(19) United States
(12) Patent Application Publication
(10) Pub. No.: US 2026/0227618 A1
(43) Pub. Date: Aug. 6, 2026

(54) SYSTEM FOR USE IN STRUCTURED ILLUMINATION MICROSCOPY

(71) Applicant: University of Strathclyde, Glasgow (GB)

(72) Inventors: Ralf Bauer, Glasgow (GB); Peter William Tinning, Glasgow (GB)

(21) Appl. No.: 19/148,071

(22) PCT Filed: Jul. 9, 2024
(86) PCT No.: PCT/GB2024/051784

§ 371 Date: Jul. 15, 2025

(30) Foreign Application Priority Data
Jul. 10, 2023 (GB) 2310550.5

(51) Int. Cl. G02B 21/18; G01N 21/64; G02B 21/08

(52) U.S. Cl. CPC G02B 21/18; G01N 21/6458; G02B 21/08

(57) ABSTRACT

A system for use in structured illumination microscopy (SIM) includes a beam splitter for splitting an input light beam into first and second light beams; a first mirror for reflecting the first light beam back to the beam splitter; and a second mirror for reflecting the second light beam back to the beam splitter. In use, the beam splitter at least partially transmits or reflects the reflected first light beam to form a first output light beam and the beam splitter at least partially transmits or reflects the reflected second light beam to form a second output light beam. One or both of the first and second mirrors includes a micro-electro-mechanical systems (MEMS) mirror, wherein each MEMS mirror is rotatable around a corresponding first axis, each MEMS mirror is rotatable around a corresponding second axis, and each MEMS mirror is configured for translation along a corresponding third axis which is orthogonal to the corresponding first and second axes. A SIM system includes the system for use in SIM and one or more optical sources for generating the input light beam.

### FIELD

The present disclosure relates to a system for use in structured illumination microscopy (SIM) and a SIM system for use, in particular though not exclusively, in 2D SIM, 3D SIM, square lattice SIM, hexagonal lattice SIM or non-linear SIM.

### BACKGROUND

It is known to illuminate a sample with a structured light and to capture an image of the electromagnetic radiation generated in the sample as a result of the illumination of the sample with the structured light for the purposes of enhancing the resolution of the image. For example, structured illumination microscopy (SIM) is a fluorescence super-resolution microscopy approach that in its basic form requires the use of illumination patterns with different angles and phases in a sample to excite fluorescence in the sample and recover high resolution sample details that would not normally be accessible through the optics of the microscope. For example, for 2D resolution enhancement (2D-SIM) it is known to interfere two light beams in a sample to generate illumination patterns which are periodic in one dimension and to use a minimum of three different illumination pattern orientations and three different phases for each different illumination pattern orientation. For 3D resolution enhancement (3D-SIM) it is also known to interfere three light beams in a sample and to use a minimum of three different illumination pattern orientations and five different phases for each different illumination pattern orientation.

Diffractive 2D-SIM and 3D-SIM systems are known which use diffractive components, such as diffraction gratings, spatial light modulators (SLMs) or digital micromirror devices (DMDs), to generate multiple beams of light and which interfere the multiple beams of light in a sample. However, such known 2D-SIM and 3D-SIM systems may be relatively large and complex and may require a relatively large number of optical components. Moreover, such known 2D-SIM and 3D-SIM systems may need to be reconfigured when wishing to illuminate a sample with a different wavelength of light and may not be suitable when wishing to illuminate a sample with multiple different wavelengths of light simultaneously or when wishing to illuminate a sample with light having a broader spectral bandwidth.

Reflective 2D-SIM and 3D-SIM systems are also known which use galvanometric mirrors and piezoelectric phase shifters to generate multiple beams of light and which interfere the multiple beams of light in a sample. Unlike known diffractive 2D-SIM and 3D-SIM systems, known reflective 2D-SIM and 3D-SIM systems may not require reconfiguration when wishing to illuminate a sample with different wavelengths of light and may enable illumination of a sample with multiple different wavelengths of light simultaneously and/or illumination of a sample with light having a broader spectral bandwidth. However, known reflective 2D-SIM and 3D-SIM systems may be relatively large and complex and/or may require a relatively large number of optical components. In addition, known reflective 2D-SIM and 3D-SIM systems may provide limited imaging functionality or may lack versatility.

### SUMMARY

According to an aspect of the present disclosure there is provided a system for use in structured illumination microscopy (SIM), the system comprising:
a beam splitter for splitting an input light beam into first and second light beams,
a first mirror for reflecting the first light beam back to the beam splitter; and
a second mirror for reflecting the second light beam back to the beam splitter,
wherein the beam splitter at least partially transmits or reflects the reflected first light beam to form a first output light beam and the beam splitter at least partially transmits or reflects the reflected second light beam to form a second output light beam,
wherein one or both of the first and second mirrors comprises a micro-electro-mechanical systems (MEMS) mirror, and
wherein each MEMS mirror is rotatable around a corresponding first axis, each MEMS mirror is rotatable around a corresponding second axis, and each MEMS mirror is configured for translation along a corresponding third axis which is orthogonal to the corresponding first and second axes.

Such a reflective SIM system may be relatively compact, relatively simple, and may require a relatively small number of optical components compared with known reflective SIM systems. In addition, such a reflective SIM system may provide a greater range of imaging functionality and/or may be more versatile than known reflective SIM systems.

Optionally, the system is configured so that an optical axis of the first mirror is parallel to, or co-axial with, the first light beam.

Optionally, the optical axis of the first mirror is parallel to, or co-axial with, the third axis of the first mirror.

Optionally, the system is configured so that an optical axis of the second mirror is parallel to the second light beam.

Optionally, the optical axis of the second mirror is parallel to, or co-axial with, the third axis of the second mirror.

Optionally, the beam splitter is configured so that the first and second light beams propagate along orthogonal directions.

Optionally, the beam splitter and the first and second mirrors are arranged in a Michelson interferometer configuration.

Optionally, there are no optical components located between the beam splitter and the first mirror and/or there are no optical components located between the beam splitter and the second mirror.

Optionally, the beam splitter comprises a beam splitting cube.

Optionally, the beam splitter comprises a non-polarising beam splitter.

Optionally, the system comprises a polarisation control arrangement for controlling or selecting a polarisation of the first output light beam and for controlling or selecting a polarisation of the second output light beam to form first and second tangentially polarised output light beams having the same tangential linear polarisation relative to an optical axis of the polarisation control arrangement.

Optionally, the polarisation control arrangement comprises a pizza polariser positioned after the non-polarising beam splitter, wherein the pizza polariser has an even number of segments and each segment is configured to linearly polarise a light beam incident on the segment with a corresponding linear polarisation in a tangential direction relative to an optical axis of the pizza polariser, and wherein the pizza polariser is positioned relative to the first and second output light beams so that opposing segments linearly polarise the first and second output light beams with the same tangential linear polarisation.

Optionally, the polarisation control arrangement comprises an output circular polariser positioned between the non-polarising beam splitter and the pizza polariser so that the first and second output light beams incident on the pizza polariser are circularly polarised.

Optionally, the polarisation control arrangement comprises an output quarter waveplate which is positioned between the non-polarising beam splitter and the pizza polariser so that the first and second output light beams incident on the pizza polariser are circularly polarised. Such a polarisation control arrangement may be used to convert linearly polarised light into circularly polarised light at a position between the non-polarising beam splitter and the pizza polariser. This may, for example, be useful when the input light beam is linearly polarised.

Optionally, the polarisation control arrangement comprises an input circular polariser which is positioned before the non-polarising beam splitter and which is configured to circularly polarise the input light beam.

Optionally, the polarisation control arrangement comprises an input quarter waveplate which is positioned before the non-polarising beam splitter and which is configured to circularly polarise the input light beam when the input light beam is linearly polarised.

Optionally, the polarisation control arrangement comprises a linear polariser followed by an m=1 vortex half-wave retarder, wherein the linear polariser and the m=1 vortex half-wave retarder are both positioned after the non-polarising beam splitter.

Optionally, the beam splitter comprises a polarising beam splitter.

Optionally, the system comprises a polarisation control arrangement for controlling or selecting a polarisation of the first output light beam and a polarisation of the second output light beam to form first and second tangentially polarised output light beams having the same tangential linear polarisation relative to an optical axis of the polarisation control arrangement.

Optionally, the polarisation control arrangement comprises a pizza polariser positioned after the polarising beam splitter and an output quarter waveplate positioned between the polarising beam splitter and the pizza polariser, wherein the pizza polariser has an even number of segments and each segment is configured to linearly polarise a light beam incident on the segment with a corresponding linear polarisation in a tangential direction relative to an optical axis of the pizza polariser, and wherein the output quarter waveplate and the pizza polariser are positioned relative to the first and second output light beams so that the output quarter waveplate circularly polarises the first and second output light beams and opposing segments of the pizza polariser linearly polarise the first and second circularly polarised output light beams with the same tangential linear polarisation.

Optionally, wherein the polarisation control arrangement comprises a linear polariser followed by an m=1 vortex half-wave retarder, wherein the linear polariser and the m=1 vortex half-wave retarder are both positioned after the polarising beam splitter. Optionally, wherein the polarisation control arrangement comprises an input circular polariser which is positioned before the polarising beam splitter and which is configured to circularly polarise the input light beam.

Optionally, the polarisation control arrangement comprises an input quarter waveplate which is positioned before the polarising beam splitter and which is configured to circularly polarise the input light beam when the input light beam is linearly polarised.

Optionally, the system comprises:
a main beam splitter for splitting a main input light beam into the input light beam and a further input light beam;
a further beam splitter for splitting the further input light beam into third and fourth light beams;
a third mirror for reflecting the third light beam back to the further beam splitter; and
a fourth mirror for reflecting the fourth light beam back to the further beam splitter,
wherein the further beam splitter at least partially transmits or reflects the reflected third light beam to form a third output light beam and the further beam splitter at least partially transmits or reflects the reflected fourth light beam to form a fourth output light beam,
wherein the main beam splitter at least partially transmits or reflects the first output light beam to form a first main output light beam, at least partially transmits or reflects the second output light beam to form a second main output light beam, at least partially transmits or reflects the third output light beam to form a third main output light beam, and at least partially transmits or reflects the fourth output light beam to form a fourth main output light beam,
wherein one or both of the third and fourth mirrors comprises a micro-electro-mechanical systems (MEMS) mirror, and
wherein each MEMS mirror is rotatable around a corresponding first axis, each MEMS mirror is rotatable around a corresponding second axis, and each MEMS mirror is configured for translation along a corresponding third axis which is orthogonal to the corresponding first and second axes.

Optionally, the system is configured so that an optical axis of the third mirror is parallel to, or co-axial with, the third light beam.

Optionally, the optical axis of the third mirror is parallel to, or co-axial with, the third axis of the third mirror; and/or Optionally, the system is configured so that an optical axis of the fourth mirror is parallel to, or co-axial with, the fourth light beam.

Optionally, the optical axis of the fourth mirror is parallel to, or co-axial with, the third axis of the fourth mirror.

Optionally, the beam splitter is configured so that the third and fourth light beams propagate along orthogonal directions.

Optionally, the further beam splitter and the third and fourth mirrors are arranged in a Michelson interferometer configuration.

Optionally, there are no optical components located between the further beam splitter and the third mirror and/or there are no optical components located between the further beam splitter and the fourth mirror.

Optionally, the further beam splitter comprises a beam splitting cube.

Optionally, the main beam splitter comprises a beam splitting cube.

Optionally, the main beam splitter, the beam splitter and the further beam splitter comprise non-polarising beam splitters.

Optionally, the system comprises a polarisation control arrangement for controlling or selecting a polarisation of at least two of the first, second, third and fourth main output light beams.

Optionally, the polarisation control arrangement comprises a pizza polariser positioned after the mean non-polarising beam splitter, wherein the pizza polariser has an even number of segments and each segment is configured to linearly polarise a light beam incident on the segment with a corresponding linear polarisation in a tangential direction relative to an optical axis of the pizza polariser, and wherein the pizza polariser is positioned relative to at least two of the first, second, third and fourth main output light beams so that at least two of the segments linearly polarise at least two of the first, second, third and fourth main output light beams so as to form at least two tangentially polarised main output light beams relative to an optical axis of the pizza polariser.

Optionally, the polarisation control arrangement comprises an output circular polariser positioned between the main non-polarising beam splitter and the pizza polariser. Optionally, the polarisation control arrangement comprises an output quarter waveplate positioned between the main non-polarising beam splitter and the pizza polariser.

Optionally, the pizza polariser has a central non-polarising region. Optionally, the pizza polariser is positioned relative to one of the first, second, third and fourth main output light beams so that said one of the first, second, third and fourth main output light beams is transmitted through the central non-polarising region of the pizza polariser.

Optionally, the polarisation control arrangement comprises an input circular polariser positioned before the main non-polarising beam splitter for circular polarising the main input light beam.

Optionally, the polarisation control arrangement comprises an input quarter waveplate positioned before the main non-polarising beam splitter for circular polarising the main input light beam when the main input light beam is linearly polarised.

Optionally, the polarisation control arrangement comprises a linear polariser followed by an m=1 vortex half-wave retarder, wherein the linear polariser and the m=1 vortex half-wave retarder are both positioned after the main non-polarising beam splitter. Optionally, the main beam splitter comprises a non-polarising beam splitter and the beam splitter and the further beam splitter comprise polarising beam splitters. Optionally, the system comprises a polarisation control arrangement for controlling or selecting a polarisation of at least two of the first, second, third and fourth main output light beams.

Optionally, the polarisation control arrangement comprises a pizza polariser positioned after the main non-polarising beam splitter and an output quarter waveplate positioned between the main non-polarising beam splitter and the pizza polariser, wherein the pizza polariser has an even number of segments and each segment is configured to linearly polarise a light beam incident on the segment with a corresponding linear polarisation in a tangential direction relative to an optical axis of the pizza polariser, and wherein the pizza polariser is positioned relative to the first, second, third and fourth main output light beams so that at least two of the segments linearly polarise at least two of the first, second, third and fourth main output light beams so as to form at least two tangentially polarised main output light beams relative to an optical axis of the pizza polariser.

Optionally, the pizza polariser has a central non-polarising region. Optionally, the pizza polariser is positioned relative to one of the first, second, third and fourth main output light beams so that said one of the first, second, third and fourth main output light beams is transmitted through the central non-polarising region of the pizza polariser.

Optionally, wherein the polarisation control arrangement comprises a linear polariser followed by an m=1 vortex half-wave retarder, wherein the linear polariser and the m=1 vortex half-wave retarder are both positioned after the main non-polarising beam splitter.

Optionally, the polarisation control arrangement comprises an input circular polariser which is positioned before the main non-polarising beam splitter for circular polarising the main input light beam.

Optionally, the polarisation control arrangement comprises an input quarter waveplate which is positioned before the main non-polarising beam splitter for circular polarising the main input light beam when the main input light beam is linearly polarised.

Optionally, there are no optical components located between the main beam splitter and the beam splitter and/or there are no optical components located between the main beam splitter and the further beam splitter.

Optionally, the main beam splitter, the beam splitter and the further beam splitter comprise polarising beam splitters.

Optionally, the system comprises a first quarter waveplate located between the main polarising beam splitter and the polarising beam splitter and a second quarter waveplate located between the main polarising beam splitter and the further polarising beam splitter.

Optionally, the system comprises a polarisation control arrangement for controlling or selecting a polarisation of at least two of the first, second, third and fourth main output light beams.

Optionally, the polarisation control arrangement comprises a pizza polariser positioned after the main polarising beam splitter and an output quarter waveplate positioned between the main polarising beam splitter and the pizza polariser, wherein the pizza polariser has an even number of segments and each segment is configured to linearly polarise a light beam incident on the segment with a corresponding linear polarisation in a tangential direction relative to an optical axis of the pizza polariser, and wherein the pizza polariser is positioned relative to the first, second, third and fourth main output light beams so that at least two of the segments linearly polarise at least two of the first, second, third and fourth main output light beams so as to form at least two tangentially polarised main output light beams relative to an optical axis of the pizza polariser.

Optionally, the pizza polariser has a central non-polarising region. Optionally, the pizza polariser is positioned relative to one of the first, second, third and fourth main output light beams so that said one of the first, second, third and fourth main output light beams is transmitted through the central non-polarising region of the pizza polariser.

Optionally, wherein the polarisation control arrangement comprises a linear polariser followed by an m=1 vortex half-wave retarder, wherein the linear polariser and the m=1 vortex half-wave retarder are both positioned after the main polarising beam splitter.

Optionally, the polarisation control arrangement comprises an input circular polariser which is positioned before the main polarising beam splitter for circular polarising the main input light beam.

Optionally, the polarisation control arrangement comprises an input quarter waveplate which is positioned before the main polarising beam splitter for circular polarising the main input light beam when the main input light beam is linearly polarised. Optionally, the corresponding first axis and the corresponding second axis of each MEMS mirror are orthogonal.

Optionally, each MEMS mirror is rotatable around the corresponding first axis continuously over a corresponding angular range, each MEMS mirror is rotatable around the corresponding second axis continuously over a corresponding angular range, and each MEMS mirror is configured for translation along the corresponding third axis continuously over a corresponding linear range.

Optionally, the system comprises an optical coupling arrangement for optically coupling the first and second output light beams, or at least two of the first, second, third and fourth main output light beams to a sample at a sample position so as to generate an interference pattern for the generation of electromagnetic radiation in the regions of the sample illuminated by the interference pattern.

Optionally, the optical coupling arrangement comprises a focussing arrangement and a collimating arrangement, wherein the focussing arrangement is configured to focus each of the first and second output light beams, or each of at least two of the first, second, third and fourth main output light beams to a corresponding focal position in a back focal plane of the collimating arrangement so that the collimating arrangement collimates and interferes the first and second output light beams, or at least two of the first, second, third and fourth main output light beams, at the sample position to form the interference pattern at the sample position.

Optionally, the focussing arrangement comprises a focussing lens.

Optionally, the collimating arrangement comprises an objective lens.

Optionally, the electromagnetic radiation comprises fluorescence.

Optionally, the system comprises an image sensor arrangement.

Optionally, the optical coupling arrangement is configured to optically couple the first and second output light beams, or at least two of the first, second, third and fourth main output light beams, to a first side of the sample and to optically couple at least a portion of the generated electromagnetic radiation emitted from the first side of the sample to the image sensor arrangement. Such an optical coupling arrangement may be useful when wishing to perform imaging in an epi-detection configuration.

Optionally, the optical coupling arrangement comprises a reflector arrangement which is located before the collimating arrangement and which is configured to:
at least partially transmit the output light beams towards the collimating arrangement for the generation of electromagnetic radiation in the sample and to at least partially reflect at least a portion of the generated electromagnetic radiation towards the image sensor arrangement, or
at least partially reflect the output light beams towards the collimating arrangement for the generation of electromagnetic radiation in the sample and to at least partially transmit at least a portion of the generated electromagnetic radiation towards the image sensor arrangement.

Optionally, the reflector arrangement comprises a partial reflector or a beam splitter such as a non-polarising beam splitter or wherein the reflector arrangement comprises a dichroic mirror.

Optionally, the optical coupling arrangement is configured to optically couple the first and second output light beams, or at least two of the first, second, third and fourth main output light beams, to a first side of the sample and the system comprises a further optical coupling arrangement for optically coupling at least a portion of the generated electromagnetic radiation emitted from a second side of the sample to the image sensor arrangement, wherein the second side of the sample is opposite to the first side of the sample.

Optionally, the system comprises a controller which is configured to control:
a rotation of each MEMS mirror around the corresponding first axis;
a rotation of each MEMS mirror around the corresponding second axis; and
a position of each MEMS mirror along the corresponding third axis.

Optionally, the controller is configured to control each MEMS mirror to select the focal positions of the first and second output light beams, or of at least two of the first, second, third and fourth main output light beams, in the back focal plane of the collimating arrangement.

Optionally, the controller is configured to control the image sensor arrangement to capture an image of the electromagnetic radiation emitted from the sample when the sample is illuminated by an interference pattern corresponding to each focal position arrangement of a plurality of focal position arrangements and to reconstruct an image of the sample based on the captured images, wherein each focal position arrangement comprises an arrangement of the first and second output light beams, or of at least two of the first, second, third and fourth output light beams, in the back focal plane of the collimating arrangement.

Optionally, the controller is configured to control each MEMS mirror for 2D SIM. Optionally, the controller is configured to control the image sensor arrangement to capture an image of the electromagnetic radiation emitted from the sample when the sample is illuminated by the interference pattern corresponding to each focal position arrangement of a plurality of focal position arrangements of the first and second output light beams in the back focal plane of the collimating arrangement and to reconstruct an image of the sample based on the captured images.

Optionally, the controller is configured to control each MEMS mirror so as to arrange the first and second focal positions of the first and second output light beams in the back focal plane of the collimating arrangement according to first, second and third focal position arrangements, wherein in the first focal position arrangement the first and second focal positions are aligned along a first axis, in the second focal position arrangement the first and second focal positions are aligned along a second axis arranged at an angle of +θ relative to the first axis, and in the third focal position arrangement the first and second focal positions are aligned along a third axis arranged at an angle of −θ relative to the first axis, and wherein the separation of the first and second focal positions is the same for each of the first, second and third focal position arrangements.

Optionally, θ is in the range of 45 degrees to 75 degrees, θ is in the range of 55 degrees to 65 degrees, θ is substantially equal to 60 degrees or θ is equal to 60 degrees. For 2D SIM, it is generally accepted that using angles θ of 60 degrees (positive and negative) provides the best compromise between uniform resolution enhancements and minimum number of required focal position arrangements.

Optionally, the controller is configured to control each MEMS mirror to vary the phase difference between the first and second output light beams for each for each of the first, second and third focal position arrangements.

Optionally, the controller is configured to control each MEMS mirror to provide first, second and third phase differences between the first and second output light beams for each for each of the first, second and third focal position arrangements.

Optionally, the first phase difference is 0 radians, the second phase difference is 2 π/3 radians and the third phase difference is 4 π/3 radians.

Optionally, the controller is configured to control each MEMS mirror to select a separation between the first and second focal positions in the back focal plane of the collimating arrangement for each of the first, second and third focal position arrangements.

Optionally, the controller is configured to control the image sensor arrangement to capture an image of the electromagnetic radiation emitted from the sample when the sample is illuminated by the interference pattern corresponding to each focal position arrangement of a plurality of focal position arrangements of three or four of the first, second, third and fourth main output light beams in the back focal plane of the collimating arrangement and to reconstruct an image of the sample based on the captured images.

Optionally, the controller is configured to control each MEMS mirror so that the collimating arrangement collimates and interferes three of the first, second, third and fourth main output light beams at the sample position to form an interference pattern at the sample position for 3D SIM.

Optionally, a central one of the three interfering main output light beams is circularly polarised, and the radially outer two of the three interfering main output light beams are linearly polarised with the same tangential linear polarisation.

Optionally, the controller is configured to control each MEMS mirror so as to arrange three of the first, second, third and fourth focal positions according to first, second and third focal position arrangements, wherein in the first focal position arrangement three of the first, second, third and fourth focal positions are aligned along a first axis, in the second focal position arrangement three of the first, second, third and fourth focal positions are aligned along a second axis arranged at an angle of +θ relative to the first axis, and in the third focal position arrangement three of the first, second, third and fourth focal positions are aligned along a third axis arranged at an angle of −θ relative to the first axis, and wherein the relative separations of the three of the first, second, third and fourth focal positions are the same for each of the first, second and third focal position arrangements.

Optionally, θis in the range of 45 degrees to 75 degrees, θ is in the range of 55 degrees to 65 degrees, θ is substantially equal to 60 degrees or θ is equal to 60 degrees. For 3D SIM, it is generally accepted that using angles θ of 60 degrees (positive and negative) provides the best compromise between uniform resolution enhancements and minimum number of required focal position arrangements.

Optionally, the controller is configured to control each MEMS mirror to vary the phase difference between the three of the first, second, third and fourth main output light beams for each of the first, second and third focal position arrangements.

Optionally, the controller is configured to control each MEMS mirror to provide first, second, third, fourth and fifth phase differences between the three of the first, second, third and fourth main output light beams for each of the first, second and third focal position arrangements.

Optionally, the first phase difference is 0 radians, the second phase difference is 2 π/5 radians, the third phase difference is 4 π/5 radians, the fourth phase difference is 6 π/5 radians and the fifth phase difference is 8 π/5 radians.

Optionally, the controller is configured to control each MEMS mirror to select the relative separations of the three of the first, second, third and fourth focal positions in the back focal plane of the collimating arrangement for each of the first, second and third focal position arrangements.

Optionally, the controller is configured to control each MEMS mirror for square lattice SIM, hexagonal lattice SIM or non-linear SIM.

According to an aspect of the present disclosure there is provided a SIM system comprising:
the system for use in SIM as described above; and
an optical source for generating the input light beam or the main input light beam.

Optionally, the optical source is configured to generate the input light beam or the main input light beam with a linear polarisation.

Optionally, the optical source comprises a coherent optical source such as a laser.

Optionally, the system comprises one or more further optical sources and an optical combiner arrangement for combining light from the optical source and the one or more further optical sources to form the input light beam or the main input light beam.

Optionally, the one or more of the further optical sources is configured to emit light of a wavelength which is different to a wavelength of the light emitted by the optical source and/or wherein one or more of the further optical sources is configured to emit light having an optical spectrum which is different to an optical spectrum of the light emitted by the optical source.

It should be understood that any one or more of the optional features of any one of the foregoing aspects of the present disclosure may be combined with any one or more of the other foregoing aspects of the present disclosure or the optional features of any one or more of the other foregoing aspects of the present disclosure.

### BRIEF DESCRIPTION OF THE DRAWINGS

A system for use in generating an illumination pattern for structured illumination microscopy (SIM) and an illumination pattern generator for SIM will now be described by way of non-limiting example only with reference to the drawings of which:

FIG. 1 is a plan view schematic of a first system for use in structured illumination microscopy (SIM);

FIG. 2A is a plan view schematic of a second system for use in structured illumination microscopy (SIM);

FIG. 2B is a front view schematic of a segmented or pizza polariser of the second system of FIG. 2A;

FIG. 3 is a plan view schematic of a third system for use in structured illumination microscopy (SIM);

FIG. 4A is a perspective view schematic of a MEMS mirror during rotation about a first axis;

FIG. 4B is a perspective view schematic of the MEMS mirror of FIG. 4A during rotation about a second axis orthogonal to the first axis;

FIG. 4C is a perspective view schematic of the MEMS mirror of FIGS. 4A and 4B during a piston movement;

FIG. 5A is a front view schematic of a first focal position arrangement of first and second output light beams in a back focal plane of an objective lens of the first system of FIG. 1 and the corresponding interference patterns formed at a sample position for three different phase differences between the first and second output light beams;

FIG. 5B is a front view schematic of a second focal position arrangement of the first and second output light beams in the back focal plane of the objective lens of the first system of FIG. 1 and a corresponding interference pattern formed at the sample position;

FIG. 5C is a front view schematic of a third focal position arrangement of the first and second output light beams in the back focal plane of the objective lens of the first system of FIG. 1 and a corresponding interference pattern formed at the sample position;

FIG. 5D is a front view schematic of a fourth focal position arrangement of the first and second output light beams in the back focal plane of the objective lens of the first system of FIG. 1 and a corresponding intermediate spatial frequency interference pattern formed at the sample position;

FIG. 5E is a front view schematic of a fifth focal position arrangement of the first and second output light beams in the back focal plane of the objective lens of the first system of FIG. 1 and a corresponding higher spatial frequency interference pattern formed at the sample position;

FIG. 5F is a front view schematic of a sixth focal position arrangement of the first and second output light beams in the back focal plane of the objective lens of the first system of FIG. 1 and a corresponding lower spatial frequency interference pattern formed at the sample position;

FIG. 6A is a front view schematic of a first focal position arrangement of first and second tangentially polarised output light beams in a back focal plane of an objective lens of the second system of FIG. 2A and the corresponding interference patterns formed at a sample position for three different phase differences between the first and second output light beams;

FIG. 6B is a front view schematic of a second focal position arrangement of the first and second tangentially polarised output light beams in the back focal plane of the objective lens of the second system of FIG. 2A and a corresponding interference pattern formed at the sample position;

FIG. 6C is a front view schematic of a third focal position arrangement of the first and second tangentially polarised output light beams in the back focal plane of the objective lens of the second system of FIG. 2A and a corresponding interference pattern formed at the sample position;

FIG. 6D is a front view schematic of a fourth focal position arrangement of the first and second tangentially polarised output light beams in the back focal plane of the objective lens of the second system of FIG. 2A and a corresponding intermediate spatial frequency interference pattern formed at the sample position;

FIG. 6E is a front view schematic of a fifth focal position arrangement of the first and second tangentially polarised output light beams in the back focal plane of the objective lens of the second system of FIG. 2A and a corresponding higher spatial frequency interference pattern formed at the sample position;

FIG. 6F is a front view schematic of a sixth focal position arrangement of the first and second tangentially polarised output light beams in the back focal plane of the objective lens of the second system of FIG. 2A and a corresponding lower spatial frequency interference pattern formed at the sample position;

FIG. 7 is a plan view schematic of a fourth system for use in structured illumination microscopy (SIM);

FIG. 8 is a plan view schematic of a fifth system for use in structured illumination microscopy (SIM);

FIG. 9A is a front view schematic of a first focal position arrangement of first, second, third and fourth tangentially polarised output light beams in a back focal plane of an objective lens of the fourth system of FIG. 7 and a corresponding interference pattern formed at a sample position;

FIG. 9B is a front view schematic of a second focal position arrangement of first, second, third and fourth tangentially polarised output light beams in the back focal plane of the objective lens of the fourth system of FIG. 7 and a corresponding interference pattern formed at the sample position;

FIG. 9C is a front view schematic of a focal position arrangement of three of the first, second, third and fourth tangentially polarised output light beams in the back focal plane of the objective lens of the fourth system of FIG. 7 and a corresponding interference pattern formed at the sample position;

FIG. 9D is a front view schematic of a further focal position arrangement of three of the first, second, third and fourth tangentially polarised output light beams in the back focal plane of the objective lens of the fourth system of FIG. 7 and a corresponding interference pattern formed at the sample position; and

FIG. 10 is a plan view schematic of a sixth system for use in structured illumination microscopy (SIM).

### DETAILED DESCRIPTION OF THE DRAWINGS

Referring initially to FIG. 1 there is shown a first system generally designated 2 for use in structured illumination microscopy (SIM) of a sample 4, wherein the system 2 comprises a beam splitter in the form of a non-polarising beam splitter cube 20, and first and second MEMS mirrors 30a and 30b respectively. There are no optical components located between the beam splitter cube 20 and the first mirror 30a and there are no optical components located between the beam splitter cube 20 and the second mirror 30b.

The system 2 further comprises an optical coupling arrangement which includes a focussing arrangement in the form of a focussing lens 40 and a collimating arrangement in the form of an objective lens 44.

The optical coupling arrangement also includes a reflector arrangement in the form of a dichroic mirror 52.

The system 2 further comprises an image sensor arrangement in the form of an imaging lens 54 and an image sensor 56.

The system 2 further comprises a controller 58. As indicated by the dashed lines in FIG. 1, the controller 58 is configured to control the first and second MEMS mirrors 30 and to communicate with the image sensor 56.

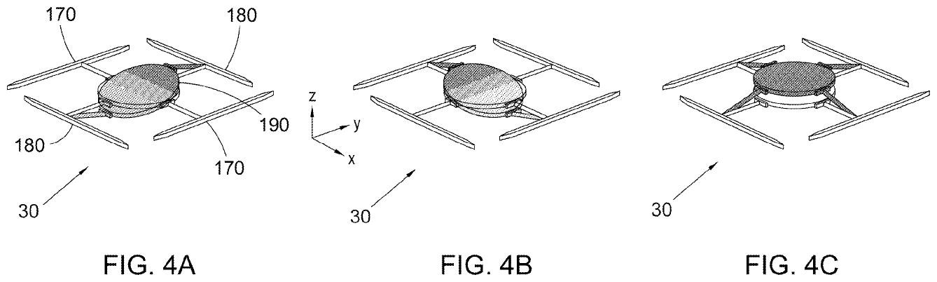

Each MEMS mirror 30a, 30b is rotatable around a corresponding first axis, each MEMS mirror is rotatable around a corresponding second axis, and each MEMS mirror is configured for translation along a corresponding third axis which is orthogonal to the corresponding first and second axes. The corresponding first axis and the corresponding second axis are orthogonal so that each mirror 30a, 30b may be controlled to provide any combination of tip, tilt and piston movements. For example, as shown for one of the mirrors 30a, 30b designated 30 in FIGS. 4A to 4C, the mirror 30 comprises a reflective surface 190, a first pair of opposing actuators 180, and a second pair of opposing actuators 170. As shown in FIG. 4A, the first pair of opposing actuators 180 are controlled to rotate the reflective surface 190 around x to create a tip movement. As shown in FIG. 4B, the second pair of opposing actuators 170 are controlled to rotate the reflective surface 190 around y to create a tilt movement. When selecting a tip or tilt movement, the opposing actuators of the relevant pair of opposing actuators are used in a push-pull configuration, wherein different drive voltages are applied to the opposing actuators. To generate a piston movement, both of the first and second pairs of opposing actuators 170 or 180 are actuated in a push-push manner to translate the reflective surface 190 in z out-of-plane as shown in FIG. 4C. The reflective surface 190 is rotatable around the x axis continuously over a corresponding angular range, the reflective surface 190 is rotatable around the corresponding y axis continuously over a corresponding angular range, and the reflective surface 190 is configured for translation along the z axis continuously over a corresponding linear range. The mirrors 30a, 30b are configured so that the tip, tilt and piston movements can be performed sequentially or simultaneously. In effect, and as will be described in more detail below, this enables each mirror 30a, 30b to control a direction and a phase of a beam of light reflected from the mirror 30a, 30b.

In use, the beam splitter cube 20 splits an input light beam 10 into first and second light beams 10a, 10b. The system 2 is configured so that the third axis of the first mirror 30a is parallel to a direction of incidence of the first light beam 10a on the first mirror 30a and the third axis of the second mirror 30b is parallel to a direction of incidence of the second light beam 10b on the second mirror 30b. Moreover, the beam splitter cube 20 is configured so that the first and second light beams 10a, 10b propagate along orthogonal directions. The first mirror 30a reflects the first light beam 10a back to the beam splitter cube 20, the second mirror 30b reflects the second light beam 10b back to the beam splitter cube 20. The beam splitter cube 20 partially transmits the reflected first light beam to form a first output light beam 32a and the beam splitter cube 20 partially reflects the reflected second light beam to form a second output light beam 32b.

The focussing lens 40 focuses each of the first and second output light beams 32a and 32b into the back focal plane 50 of the objective lens 44 through the dichroic mirror 52. The objective lens 44 collimates and interferes the output light beams 32a and 32b at a sample position in or on the sample 4 to form an interference pattern for illumination of the sample 4, wherein the interference pattern is periodic in one dimension. Illumination of the sample 4 with the interference pattern excites fluorescence in the illuminated regions of the sample 4. A portion of the fluorescence (not shown in FIG. 1) is collected by the objective lens 44 and is reflected by the dichroic mirror 52 and imaged onto the image sensor 56 by the imaging lens 54.

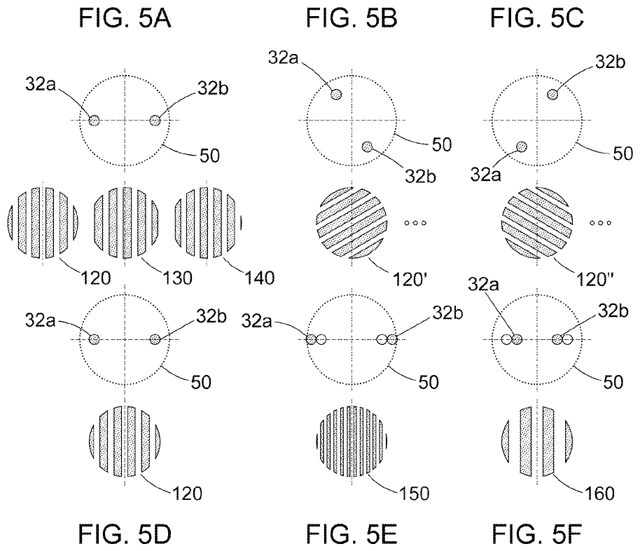

As will now be described with reference to FIGS. 5A-5F, the controller 58 controls the configurations of the MEMS mirrors 30a, 30b so as to control the focal positions of the first and second output light beams 32a, 32b in the back focal plane 50 of the objective lens 44 and the phase difference between the first and second output light beams 32a, 32b to form different interference patterns in or on the sample 4.

A minimum set of interference patterns required to reconstruct an image with full 2D resolution enhancement will now be described with reference to FIGS. 5A, 5B and 5C. With reference to FIG. 5A, the controller 58 controls the configurations of the MEMS mirrors 30a, 30b so as to arrange the focal positions of the first and second output light beams 32a, 32b in the back focal plane 50 in a first focal position arrangement in which the focal positions of the first and second output light beams 32a, 32b are arranged along a horizontal axis in the back focal plane 50 so that the objective lens 44 forms a linear interference pattern 120 along the horizontal axis in or on the sample 4. The controller 58 then controls the image sensor 56 to capture an image of the resulting fluorescence generated in the sample 4. The controller 58 then controls the piston position of one or both of the MEMS mirrors 30a, 30b so as to control the phase difference between the first and second output light beams 32a, 32b and translate the linear interference pattern horizontally across the sample 4. Specifically, as shown in FIG. 5A, the controller 58 controls the piston position of one or both of the MEMS mirrors 30a, 30b to change the phase difference between the first and second output light beams 32a, 32b by 2π/3 radians so that the objective lens 44 forms a translated linear interference pattern 130 along the horizontal axis in or on the sample 4. The controller 58 then controls the image sensor 56 to capture an image of the resulting fluorescence generated in the sample 4. The controller 58 further controls the piston position of one or both of the MEMS mirrors 30a, 30b to change the phase difference between the first and second output light beams 32a, 32b by 4π/3 radians so that the objective lens 44 forms a further translated linear interference pattern 140 along the horizontal axis in or on the sample 4. The controller 58 then controls the image sensor 56 to capture an image of the resulting fluorescence generated in the sample 4.

With reference to FIG. 5B, the controller 58 also controls the tip and tilt angles of the MEMS mirrors 30a, 30b so as to arrange the focal positions of the first and second output light beams 32a, 32b according to a second focal position arrangement in which the focal positions of the first and second output light beams 32a, 32b are arranged along an axis oriented at an angle of +60 degrees relative to the horizontal axis in the back focal plane 50 so that the objective lens 44 forms a linear interference pattern 120′ along an axis oriented at an angle of +60 degrees relative to the horizontal axis in or on the sample 4. The controller 58 then controls the image sensor 56 to capture an image of the resulting fluorescence generated in the sample 4. As for the first focal position arrangement shown in FIG. 5A, the controller 58 controls the piston position of one or both of the MEMS mirrors 30a, 30b so as to change the phase difference between the first and second output light beams 32a, 32b sequentially by 2π/3 radians and by 4π/3 radians to thereby translate the linear interference pattern 120′ sequentially along the axis oriented at the angle of +60 degrees and the controller 58 controls the image sensor 56 to capture an image of the resulting fluorescence generated in the sample 4 for each phase difference.

With reference to FIG. 5C, the controller 58 also controls the tip and tilt angles of the MEMS mirrors 30a, 30b so as to arrange the focal positions of the first and second output light beams 32a, 32b according to a third focal position arrangement in which the focal positions of the first and second output light beams 32a, 32b are arranged along an axis oriented at an angle of-60 degrees relative to the horizontal axis in the back focal plane 50 so that the objective lens 44 forms a linear interference pattern 120″ along an axis oriented at an angle of −60 degrees relative to the horizontal axis in or on the sample 4. The controller 58 then controls the image sensor 56 to capture an image of the resulting fluorescence generated in the sample 4. As for the first focal position arrangement shown in FIG. 5A, the controller 58 controls the piston position of one or both of the MEMS mirrors 30a, 30b so as to change the phase difference between the first and second output light beams 32a, 32b sequentially by 2π/3 radians and by 4π/3 radians to thereby translate the linear interference pattern 120″ sequentially along the axis oriented at the angle of −60 degrees and the controller 58 controls the image sensor 56 to capture an image of the resulting fluorescence generated in the sample 4 for each phase difference.

One of ordinary skill in the art will understand that the controller 58 uses a known 2D SIM image reconstruction method to reconstruct an image of the sample 4 using the nine images of the different fluorescence distributions generated in the sample 4 corresponding to the three different phase differences for each of the first, second and third focal position arrangements.

Since the tilt and tip angles of the MEMS mirrors 30a, 30b may be varied continuously over their respective angular ranges, use of the MEMS mirrors 30a, 30b, means that the controller 58 can control the tilt and tip angles of the MEMS mirrors 30a, 30b to control the separation of the focal positions of the first and second output light beams 32a, 32b in the back focal plane 50 continuously over a corresponding range of separations. In effect, this means that the controller 58 can control the spatial frequency of the interference pattern formed by the objective lens 44. For example, the controller 58 can control the tilt and tip angles of the MEMS mirrors 30a, 30b so that the objective lens 44 forms an interference pattern with an intermediate spatial frequency like the interference pattern 120 shown in FIG. 5D, an interference pattern with a higher spatial frequency like the interference pattern 150 shown in FIG. 5E, or an interference pattern with a lower spatial frequency like the interference pattern 160 shown in FIG. 5F. Use of the interference pattern 150 with the higher spatial frequency shown in FIG. 5E may allow recovery of higher resolution information. Use of the interference pattern 160 with the lower spatial frequency shown in FIG. 5F may reduce the achievable resolution enhancement, but may improve the background removal and optical sectioning ability of the image post-processing routines.

From the foregoing description, one of skill in the art will understand that the system 2 is not only compact, but is also versatile in the sense that the system 2 can enable the generation of a wide range of different illumination patterns for structured illumination microscopy (SIM). Moreover, since the MEMS mirrors 30a, 30b are achromatic, the system 2 can be used with an input light beam 10 which includes a plurality of different wavelengths or an input light beam 10 having a broader spectral range than would be possible for diffractive SIM systems.

From the foregoing description, one of skill in the art will also understand that if the input light beam 10 is linearly polarised in the vertical direction, the first and second output light beams 32a, 32b will also be linearly polarised in the vertical direction between the beam splitter cube 20 and the sample 4 for the first focal position arrangement shown in FIG. 5A. However, the same is not true for the second and third focal position arrangements shown in FIGS. 5B and 5C respectively when the first and second output light beams 32a, 32b are no longer in a horizontal plane and the focal positions of the first and second output light beams 32a, 32b in the back focal plane 50 are no longer aligned on the horizontal axis because refraction of the first and second output light beams 32a, 32b at the objective lens 44 means that the polarisation of the first and second output light beams 32a, 32b is no longer vertical at the sample 4 resulting in a reduction in the contrast of the interference patterns 120′ and 120″ shown in FIGS. 5B and 5C respectively relative to the interference patterns 120 shown in FIG. 5A. The contrast of the interference patterns 120, 120′ and 120″ shown in FIGS. 5A, 5B and 5C respectively may be further reduced for polarisation states of the input light beam 10 other than vertical linear polarisation.

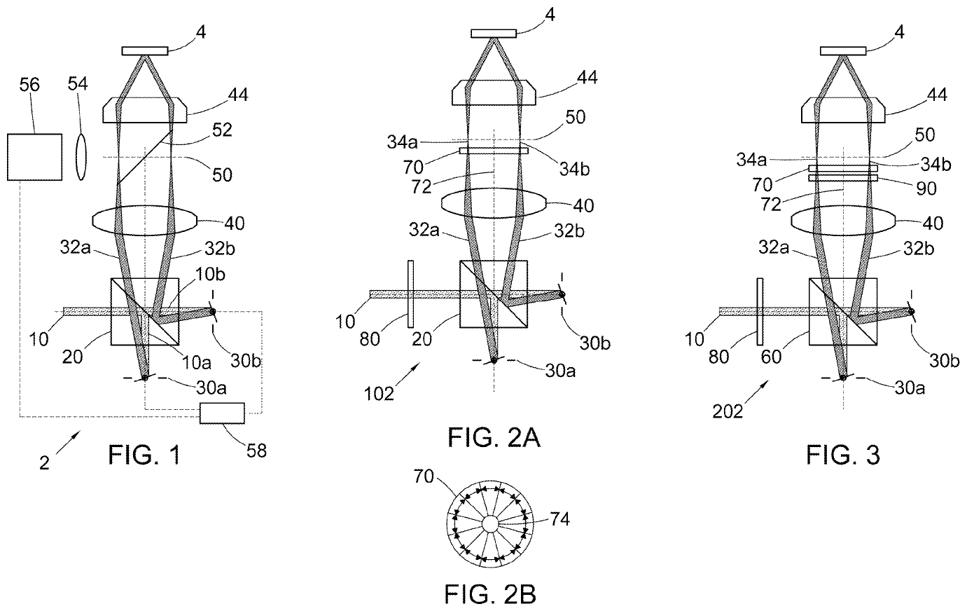

Referring now to FIG. 2A there is shown a second system generally designated 102 for use in structured illumination microscopy (SIM) of a sample 4, wherein the second system 102 comprises an additional polarisation control arrangement relative to the first system 2 of FIG. 1. Specifically, the second system 102 includes a circular polariser 80 positioned before the beam splitter cube 20 for controlling a polarisation of the input light beam 10 and a segmented or pizza polariser 70 positioned after the beam splitter cube 20 between the focusing lens 40 and the back focal plane 50 of the objective lens 44. As shown in FIG. 2B, the pizza polariser 70 has an even number of segments, wherein each segment is configured to linearly polarise a light beam incident on the segment with a corresponding linear polarisation in a tangential direction relative to an optical axis 72 of the pizza polariser 70, and wherein opposing segments are configured to linearly polarise light beams which are incident on the opposing segments with the same tangential linear polarisation. Although not shown explicitly in FIG. 2A, it should be understood that the second system 102 also includes a dichroic mirror like the dichroic mirror 52 of the system 2 of FIG. 1, an imaging lens like the imaging lens 54 of the system 2 of FIG. 1, an image sensor like the image sensor 56 of the system 2 of FIG. 1, and a controller like the controller 58 of the system 2 of FIG. 1.

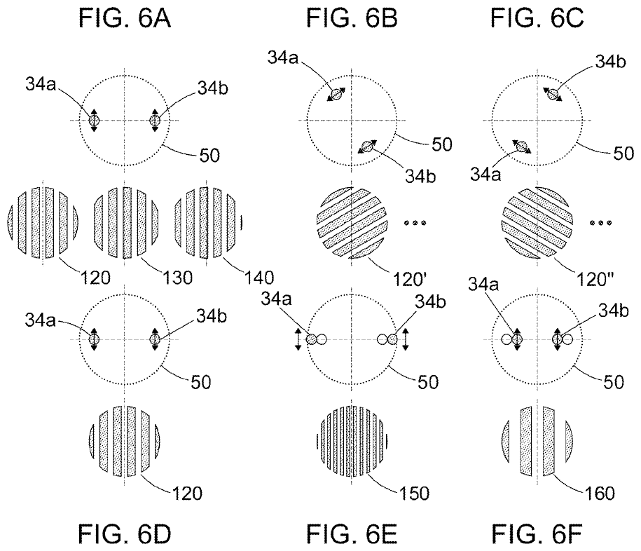

The operation of the second system 102 is very similar to the operation of the first system 2 described with reference to FIGS. 4A to 4C and FIGS. 5A to 5F except that the circular polariser 80 ensures that the light beam incident on the beam splitter cube 20 and the first and second output light beams 32a, 32b emerging from the beam splitter cube 20 are circularly polarised. The pizza polariser 70 converts the circularly polarised first and second output light beams 32a, 32b into tangentially polarised first and second output light beams 34a, 34b in the back focal plane 50 of the objective lens 44 for each of the first, second and third focal position arrangements as shown in FIGS. 6A, 6B and 6C respectively to thereby increase the image contrast of the resulting interference patterns 120′, 120″ shown in FIGS. 6B and 6C compared with the image contrast of the interference patterns 120′, 120″ shown in FIGS. 5B and 5C formed using the first system 2.

Like the first system 2, the tilt and tip angles of the MEMS mirrors 30a, 30b of the second system 102 may be varied continuously over their respective angular ranges to control the separation of the focal positions of the first and second output light beams 34a, 34b in the back focal plane 50 continuously over a corresponding range of separations to thereby control the spatial frequency of the interference pattern formed by the objective lens 44 as shown in FIGS. 6D to 6F.

One of skill in the art will understand that, in a variant of the system 102 of FIG. 2A, rather than using the circular polariser 80 to circularly polarise the input light beam 10, the circular polariser 80 may be positioned after the beam splitter cube 20 between the focussing lens 40 and the pizza polariser 70 so that the pizza polariser 70 converts the circularly polarised first and second output light beams 32a, 32b into tangentially polarised first and second output light beams 34a, 34b.

Referring now to FIG. 3 there is shown a third system generally designated 202 for use in structured illumination microscopy (SIM) of a sample 4, wherein the third system 202 comprises many of the same components as the second system 102 of FIGS. 2A and 2B. However, unlike the second system 102 of FIGS. 2A and 2B, the third system 202 includes a polarising beam splitter cube 60 in place of the non-polarising beam splitter cube 20. In addition, the third system 202 includes a polarisation control arrangement which includes a quarter waveplate 90 located between focusing lens 40 and the pizza polariser 70. Although not shown explicitly in FIG. 3, it should be understood that the third system 202 also includes a dichroic mirror like the dichroic mirror 52 of the system 2 of FIG. 1, an imaging lens like the imaging lens 54 of the system 2 of FIG. 1, an image sensor like the image sensor 56 of the system 2 of FIG. 1, and a controller like the controller 58 of the system 2 of FIG. 1.

The operation of the third system 202 is very similar to the operation of the second system 102 except that the polarising beam splitter cube 60 splits the circularly polarised incident light beam into first and second light beams with orthogonal linear polarisations. The first and second light beams are reflected by the first and second mirrors 30a, 30b respectively and subsequently reflected or transmitted by the polarising beam splitter cube 60 to emerge from the polarising beam splitter cube 60 as first and second orthogonally polarised output light beams 32a, 32b. The quarter waveplate 90 converts the orthogonally polarised first and second output light beams 32a, 32b into circularly polarised first and second output light beams. The pizza polariser 70 then converts the circularly polarised first and second output light beams into tangentially polarised first and second output light beams 34a, 34b in the back focal plane 50 of the objective lens 44 for each of the first, second and third focal position arrangements as shown in FIGS. 6A, 6B and 6C respectively to thereby increase the image contrast of the resulting interference patterns 120′, 120″ shown in FIGS. 6B and 6C compared with the image contrast of the interference patterns 120′, 120″ shown in FIGS. 5B and 5C formed using the first system 2.

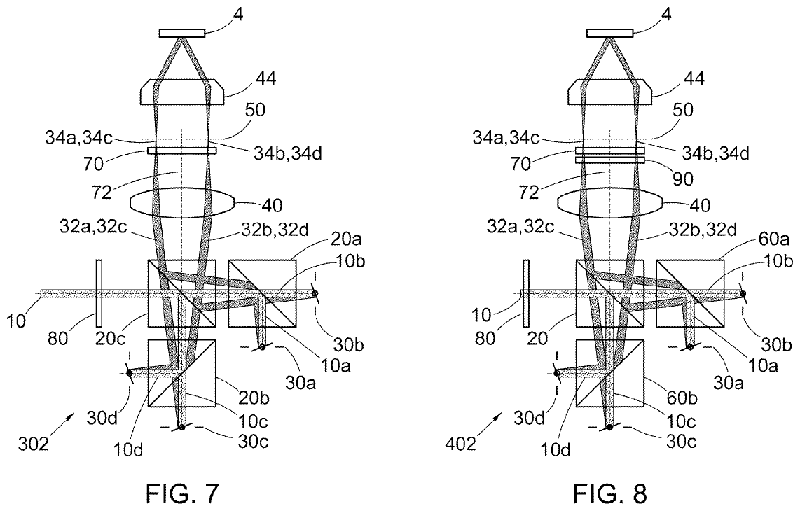

Referring now to FIG. 7 there is shown a fourth system generally designated 302 for use in structured illumination microscopy (SIM) of a sample 4, wherein the fourth system 302 comprises some of the same components as the second system 102 of FIGS. 2A and 2B. Unlike the second system 102 of FIGS. 2A and 2B, the fourth system 302 includes a non-polarising beam splitter in the form of a first non-polarising beam splitter cube 20a, a further non-polarising beam splitter in the form of second non-polarising beam splitter cube 20b, and a main non-polarising beam splitter in the form of third non-polarising beam splitter cube 20c. The system 302 further comprises first, second, third and fourth MEMS mirrors 30a, 30b, 30c, and 30d respectively. Each of the MEMS mirrors 30a, 30b, 30c, 30d is rotatable around corresponding orthogonal first and second axes and is configured for translation along a corresponding third axis which is orthogonal to the corresponding first and second axes like the MEMS mirror 30 described with reference to FIGS. 4A to 4C. There are no optical components located between any of the beam splitter cubes 20a, 20b, 20c, there are no optical components located between the first beam splitter cube 20a and the first mirror 30a, there are no optical components located between the first beam splitter cube 20a and the second mirror 30b, there are no optical components located between the second beam splitter cube 20b and the third mirror 30c, and there are no optical components located between the second beam splitter cube 20b and the fourth mirror 30d.

The system 302 further comprises an optical coupling arrangement which includes a focussing arrangement in the form of a focussing lens 40 and a collimating arrangement in the form of an objective lens 44.

The system 302 further includes a polarisation control arrangement which includes a circular polariser 80 positioned before the main non-polarising beam splitter 20c for controlling a polarisation of a main input light beam 10 and a segmented or pizza polariser 70 positioned after the main non-polarising beam splitter 20c between the focusing lens 40 and a back focal plane 50 of the objective lens 44.

Although not shown explicitly in FIG. 7, it should be understood that the fourth system 302 also includes a dichroic mirror like the dichroic mirror 52 of the system 2 of FIG. 1, an imaging lens like the imaging lens 54 of the system 2 of FIG. 1, an image sensor like the image sensor 56 of the system 2 of FIG. 1, and a controller like the controller 58 of the system 2 of FIG. 1.

In use, the circular polariser 80 circularly polarises the main input light beam 10 to form a circularly polarised main input light beam. The main beam splitter 20c splits the circularly polarised main input light beam into a first input light beam and a second input light beam. Ideally, the main beam splitter 20c splits the circularly polarised main input light beam evenly i.e. 50/50 between the first input light beam and the second input light beam.

The first beam splitter cube 20a splits the first input light beam into first and second light beams 10a, 10b. The system 302 is configured so that the third axis of the first mirror 30a is parallel to a direction of incidence of the first light beam 10a on the first mirror 30a and the third axis of the second mirror 30b is parallel to a direction of incidence of the second light beam 10b on the second mirror 30b. Moreover, the first beam splitter cube 20a is configured so that the first and second light beams 10a, 10b propagate along orthogonal directions. The first mirror 30a reflects the first light beam 10a back to the first beam splitter cube 20a and the second mirror 30b reflects the second light beam 10b back to the first beam splitter cube 20a. The first beam splitter cube 20a partially reflects the reflected first light beam to form a first output light beam and the first beam splitter cube 20a partially transmits the reflected second light beam to form a second output light beam.

Similarly, the second beam splitter cube 20b splits the second input light beam into third and fourth light beams 10c, 10d. The system 302 is configured so that the third axis of the third mirror 30c is parallel to a direction of incidence of the third light beam 10c on the third mirror 30c and the third axis of the fourth mirror 30d is parallel to a direction of incidence of the fourth light beam 10d on the fourth mirror 30d. Moreover, the second beam splitter cube 20b is configured so that the third and fourth light beams 10c, 10d propagate along orthogonal directions. The third mirror 30c reflects the third light beam 10c back to the second beam splitter cube 20b and the fourth mirror 30d reflects the fourth light beam 10d back to the second beam splitter cube 20b. The second beam splitter cube 20b partially transmits the reflected third light beam to form a third output light beam and the second beam splitter cube 20b partially reflects the reflected fourth light beam to form a fourth output light beam.

The main beam splitter 20c partially reflects the first output light beam to form a first main output light beam 32a, at least partially reflects the second output light beam to form a second main output light beam 32b, at least partially transmits the third output light beam to form a third main output light beam 32c, and at least partially transmits the fourth output light beam to form a fourth main output light beam 32d.

The focussing lens 40 focuses each of the first, second, third and fourth main output light beams 32a, 32b, 32c and 32d into the back focal plane 50 of the objective lens 44 through the pizza polariser 70 to form first, second, third and fourth tangentially polarised main output light beams 34a, 34b, 34c and 34d respectively. The objective lens 44 collimates and interferes the first, second, third and fourth tangentially polarised main output light beams 34a, 34b, 34c and 34d at a sample position in or on the sample 4 to form an interference pattern for illumination of the sample 4. Illumination of the sample 4 with the interference pattern excites fluorescence in the illuminated regions of the sample 4. A portion of the fluorescence (not shown in FIG. 7) is collected by the objective lens 44 and is reflected by the dichroic mirror (not shown in FIG. 7) and imaged onto the image sensor (not shown in FIG. 7) by the imaging lens (not shown in FIG. 7).

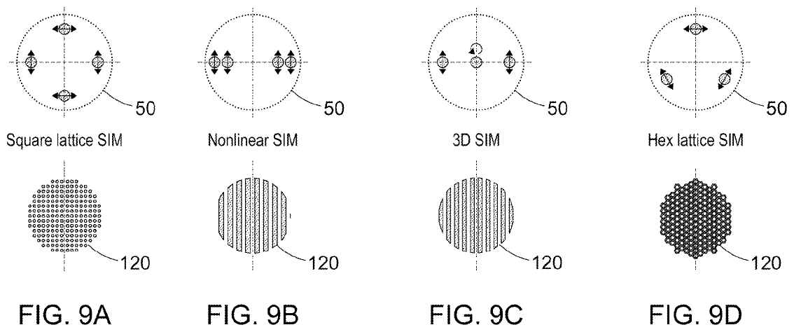

One of ordinary skill in the art will understand that the controller (not shown in FIG. 7) may rotate each MEMS mirror 30a, 30b, 30c, 30d around its corresponding first and second orthogonal axes and/or translate each MEMS mirror 30a, 30b, 30c, 30d along its corresponding third axis to form many different focal position arrangements of the first, second, third and fourth tangentially polarised main output light beams 34a, 34b, 34c and 34d in the back focal plane 50 of the objective lens 44 so that the objective lens 44 may form many different interference patterns in or on the sample 4 according to a desired SIM method. For example, FIGS. 9A and 9B show the focal position arrangements that may be formed using the first, second, third and fourth tangentially polarised main output light beams 34a, 34b, 34c and 34d in the back focal plane 50 of the objective lens 44 and the corresponding interference patterns 120 formed in or on the sample 4 by the objective lens 44 for square lattice SIM and non-linear SIM methods respectively.

One of ordinary skill in the art will also understand that the controller (not shown in FIG. 7) may rotate each MEMS mirror 30a, 30b, 30c, 30d around its corresponding first and second orthogonal axes and/or translate each MEMS mirror 30a, 30b, 30c, 30d along its corresponding third axis to control the first, second, third and fourth main output light beams 32a, 32b, 32c and 32d relative to the pizza polariser 70 for performing other SIM methods. For example, FIG. 9C shows an alternative focal position arrangement that may be formed using three of the first, second, third and fourth main output light beams 32a, 32b, 32c and 32d and the corresponding interference pattern 120 formed in or on the sample 4 by the objective lens 44 for 3D SIM, wherein the focal positions of the three main output light beams are arranged along a straight line in the back focal plane 50 of the objective lens 44, a central one of the three main output light beams is aligned with a central non-polarising region 74 of the pizza polariser 70 (see FIG. 2B) so that the central one of the three main output light beams is circularly polarised, and the radially outer two of the first, second, third and fourth main output light beams 32a, 32b, 32c and 32d are aligned with opposing segments of the pizza polariser 70 (see FIG. 2B) so that the pizza polariser 70 linearly polarises the radially outer two of the first, second, third and fourth main output light beams 32a, 32b, 32c and 32d with the same tangential linear polarisation.

FIG. 9D shows a further alternative focal position arrangement that may be formed using three of the first, second, third and fourth tangentially polarised main output light beams 34a, 34b, 34c and 34d in the back focal plane 50 of the objective lens 44 and the corresponding interference pattern 120 formed in or on the sample 4 by the objective lens 44 for hexagonal lattice SIM, wherein the focal positions of the three tangentially polarised main output light beams are arranged at the vertices of an equilateral triangle in the back focal plane 50 of the objective lens 44, and wherein each of the three tangentially polarised main output light beams are linearly polarised along a corresponding tangential direction which is arranged at 120 degrees relative to the directions of linear polarisation of the other two tangentially polarised main output light beams.

From the foregoing description, one of skill in the art will understand that the system 302 is not only compact, but is also versatile in the sense that the system 302 can enable the generation of a wide range of different illumination patterns for different structured illumination microscopy (SIM) methods. Moreover, since the MEMS mirrors 30a, 30b, 30c, 30d are achromatic, the system 302 can be used with a main input light beam 10 which includes a plurality of different wavelengths or a main input light beam 10 having a broader spectral range than would be possible for diffractive SIM systems.

One of skill in the art will understand that, in a variant of the system 302 of FIG. 7, rather than using the circular polariser 80 to circularly polarise the main input light beam 10, the circular polariser 80 may be used between the focussing lens 40 and the pizza polariser 70 so that the pizza polariser 70 converts the circularly polarised first, second, third and fourth main output light beams 32a, 32b, 32c, 32d into tangentially polarised first, second, third and fourth main output light beams 34a, 34b, 34c, 34d in the back focal plane 50 of the objective lens 44.

Referring now to FIG. 8 there is shown a fifth system generally designated 402 for use in structured illumination microscopy (SIM) of a sample 4, wherein the fifth system 402 comprises many of the same components as the fourth system 302 of FIG. 7. However, unlike the fourth system 302 of FIG. 7, the fifth system 402 includes a polarising beam splitter in the form of a first polarising beam splitter cube 60a, a further polarising beam splitter in the form of second polarising beam splitter cube 60b, and a main non-polarising beam splitter in the form of a non-polarising beam splitter cube 20. The system 402 further comprises first, second, third and fourth MEMS mirrors 30a, 30b, 30c, and 30d respectively. Each of the MEMS mirrors 30a, 30b, 30c, 30d is rotatable around corresponding orthogonal first and second axes and is configured for translation along a corresponding third axis which is orthogonal to the corresponding first and second axes like the MEMS mirror 30 described with reference to FIGS. 4A to 4C. There are no optical components located between any of the beam splitter cubes 60a, 60b, 20, there are no optical components located between the first polarising beam splitter cube 60a and the first mirror 30a, there are no optical components located between the first polarising beam splitter cube 60a and the second mirror 30b, there are no optical components located between the second polarising beam splitter cube 60b and the third mirror 30c, and there are no optical components located between the second polarising beam splitter cube 60b and the fourth mirror 30d.

The system 402 further comprises an optical coupling arrangement which includes a focussing arrangement in the form of a focussing lens 40 and a collimating arrangement in the form of an objective lens 44.

The system 402 further includes a polarisation control arrangement comprising a circular polariser 80 positioned before the main non-polarising beam splitter 20 for controlling a polarisation of a main input light beam 10 and a quarter waveplate 90 and a segmented or pizza polariser 70 positioned after the main non-polarising beam splitter 20 between the focusing lens 40 and a back focal plane 50 of the objective lens 40, wherein the quarter waveplate 90 is positioned between the focusing lens 40 and the pizza polariser 70.

Although not shown explicitly in FIG. 8, it should be understood that the fifth system 402 also includes a dichroic mirror like the dichroic mirror 52 of the system 2 of FIG. 1, an imaging lens like the imaging lens 54 of the system 2 of FIG. 1, an image sensor like the image sensor 56 of the system 2 of FIG. 1, and a controller like the controller 58 of the system 2 of FIG. 1.

In use, the circular polariser 80 circularly polarises the main input light beam 10 to form a circularly polarised main input light beam. The main beam splitter 20 splits the circularly polarised main input light beam into a first input light beam and a second input light beam.

The first polarising beam splitter cube 60a splits the first input light beam into first and second orthogonally polarised light beams 10a, 10b. The system 402 is configured so that the third axis of the first mirror 30a is parallel to a direction of incidence of the first light beam 10a on the first mirror 30a and the third axis of the second mirror 30b is parallel to a direction of incidence of the second light beam 10b on the second mirror 30b. Moreover, the first polarising beam splitter cube 60a is configured so that the first and second light beams 10a, 10b propagate along orthogonal directions. The first mirror 30a reflects the first light beam 10a back to the first polarising beam splitter cube 60a and the second mirror 30b reflects the second light beam 10b back to the first polarising beam splitter cube 60a. The first polarising beam splitter cube 60a at least partially reflects the reflected first light beam and at least partially transmits the reflected second light beam to form first and second orthogonally polarised output light beams respectively.

Similarly, the second polarising beam splitter cube 60b splits the second input light beam into third and fourth orthogonally polarised light beams 10c, 10d. The system 402 is configured so that the third axis of the third mirror 30c is parallel to a direction of incidence of the third light beam 10c on the third mirror 30c and the third axis of the fourth mirror 30d is parallel to a direction of incidence of the fourth light beam 10d on the fourth mirror 30d. Moreover, the second polarising beam splitter cube 60b is configured so that the third and fourth light beams 10c, 10d propagate along orthogonal directions. The third mirror 30c reflects the third light beam 10c back to the second polarising beam splitter cube 60b and the fourth mirror 30d reflects the fourth light beam 10d back to the second polarising beam splitter cube 60b. The second polarising beam splitter cube 60b at least partially transmits the reflected third light beam and at least partially reflects the reflected fourth light beam to form third and fourth orthogonally polarised output light beams respectively.

The main beam splitter 20 partially reflects the first output light beam to form a first main output light beam 32a, at least partially reflects the second output light beam to form a second main output light beam 32b, at least partially transmits the third output light beam to form a third main output light beam 32c, and at least partially transmits the fourth output light beam to form a fourth main output light beam 32d.

The focussing lens 40 focuses each of the first, second, third and fourth orthogonally polarised main output light beams 32a, 32b, 32c and 32d into the back focal plane 50 of the objective lens 44 through the quarter waveplate 90 to form circularly polarised main output light beams and then through the pizza polariser 70 to form first, second, third and fourth tangentially polarised main output light beams 34a, 34b, 34c and 34d respectively. The objective lens 44 collimates and interferes the first, second, third and fourth tangentially polarised main output light beams 34a, 34b, 34c and 34d at a sample position in or on the sample 4 to form an interference pattern for illumination of the sample 4. Illumination of the sample 4 with the interference pattern excites fluorescence in the illuminated regions of the sample 4. A portion of the fluorescence (not shown in FIG. 8) is collected by the objective lens 44 and is reflected by the dichroic mirror (not shown in FIG. 8) and imaged onto the image sensor (not shown in FIG. 8) by the imaging lens (not shown in FIG. 8).

One of ordinary skill in the art will understand that the controller (not shown in FIG. 8) may rotate each MEMS mirror 30a, 30b, 30c, 30d around its corresponding first and second orthogonal axes and/or translate each MEMS mirror 30a, 30b, 30c, 30d along its corresponding third axis to form many different focal position arrangements of the first, second, third and fourth tangentially polarised main output light beams 34a, 34b, 34c and 34d in the back focal plane 50 of the objective lens 44 so that the objective lens 44 may form many different interference patterns in or on the sample 4 according to a desired SIM method, for example according to any of the SIM methods described above with reference to FIGS. 9A to 9D.

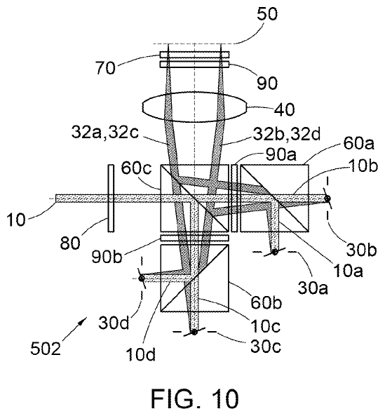

Referring now to FIG. 10 there is shown a sixth system generally designated 502 for use in structured illumination microscopy (SIM) of a sample, wherein the sixth system 502 comprises many of the same components as the fifth system 402 of FIG. 8. However, unlike the fifth system 402 of FIG. 8, the sixth system 502 includes a polarising beam splitter in the form of a first polarising beam splitter cube 60a, a further polarising beam splitter in the form of second polarising beam splitter cube 60b, and a main polarising beam splitter in the form of a third polarising beam splitter cube 60c. The system 502 further comprises first, second, third and fourth MEMS mirrors 30a, 30b, 30c, and 30d respectively. Each of the MEMS mirrors 30a, 30b, 30c, 30d is rotatable around corresponding orthogonal first and second axes and is configured for translation along a corresponding third axis which is orthogonal to the corresponding first and second axes like the MEMS mirror 30 described with reference to FIGS. 4A to 4C.

The system 502 further comprises an optical coupling arrangement which includes a focussing arrangement in the form of a focussing lens 40 and a collimating arrangement in the form of an objective lens (not shown in FIG. 10).

The system 502 further includes a polarisation control arrangement comprising a circular polariser 80 positioned before the main polarising beam splitter 60c for controlling a polarisation of a main input light beam 10, and a first quarter waveplate 90 and a segmented or pizza polariser 70 positioned after the main polarising beam splitter 60c between the focusing lens 40 and a back focal plane 50 of the objective lens, wherein the first quarter waveplate 90 is positioned between the focusing lens 40 and the pizza polariser 70. The polarisation control arrangement further comprises a second quarter waveplate 90a located between the main polarising beam splitter cube 60c and the first polarising beam splitter cube 60a, and a third quarter waveplate 90b located between the main polarising beam splitter cube 60c and the second polarising beam splitter cube 60b.

Although not shown explicitly in FIG. 10, it should be understood that the sixth system 502 also includes a dichroic mirror like the dichroic mirror 52 of the system 2 of FIG. 1, an imaging lens like the imaging lens 54 of the system 2 of FIG. 1, an image sensor like the image sensor 56 of the system 2 of FIG. 1, and a controller like the controller 58 of the system 2 of FIG. 1.

In use, the circular polariser 80 circularly polarises the main input light beam 10 to form a circularly polarised main input light beam. The main polarising beam splitter 60c splits the circularly polarised main input light beam into a first linearly polarised input light beam and a second linearly polarised input light beam.

The second quarter waveplate 90a converts the first linearly polarised input light beam into a first circularly polarised input light beam. The third quarter waveplate 90b converts the second linearly polarised input light beam into a second circularly polarised input light beam.

The first polarising beam splitter cube 60a splits the first circularly polarised input light beam into first and second orthogonally polarised light beams 10a, 10b. The system 502 is configured so that the third axis of the first mirror 30a is parallel to a direction of incidence of the first light beam 10a on the first mirror 30a and the third axis of the second mirror 30b is parallel to a direction of incidence of the second light beam 10b on the second mirror 30b. Moreover, the first polarising beam splitter cube 60a is configured so that the first and second light beams 10a, 10b propagate along orthogonal directions. The first mirror 30a reflects the first light beam 10a back to the first polarising beam splitter cube 60a and the second mirror 30b reflects the second light beam 10b back to the first polarising beam splitter cube 60a. The first polarising beam splitter cube 60a at least partially reflects the reflected first light beam and at least partially transmits the reflected second light beam to form first and second orthogonally polarised output light beams respectively. The second quarter waveplate 90a converts the first and second orthogonally polarised output light beams into first and second circularly polarised output light beams respectively.

Similarly, the second polarising beam splitter cube 60b splits the second circularly polarised input light beam into third and fourth orthogonally polarised light beams 10c, 10d. The system 502 is configured so that the third axis of the third mirror 30c is parallel to a direction of incidence of the third light beam 10c on the third mirror 30c and the third axis of the fourth mirror 30d is parallel to a direction of incidence of the fourth light beam 10d on the fourth mirror 30d. Moreover, the second polarising beam splitter cube 60b is configured so that the third and fourth light beams 10c, 10d propagate along orthogonal directions. The third mirror 30c reflects the third light beam 10c back to the second polarising beam splitter cube 60b and the fourth mirror 30d reflects the fourth light beam 10d back to the second polarising beam splitter cube 60b. The second polarising beam splitter cube 60b at least partially transmits the reflected third light beam and at least partially reflects the reflected fourth light beam to form third and fourth orthogonally polarised output light beams respectively. The third quarter waveplate 90b converts the third and fourth orthogonally polarised output light beams into third and fourth circularly polarised output light beams respectively.

The main polarising beam splitter 60c partially reflects the first circularly polarised output light beam to form a first linearly polarised main output light beam 32a, at least partially reflects the second circularly polarised output light beam to form a second linearly polarised main output light beam 32b, at least partially transmits the third circularly polarised output light beam to form a third linearly polarised main output light beam 32c, and at least partially transmits the fourth circularly polarised output light beam to form a fourth linearly polarised main output light beam 32d.

The focussing lens 40 focuses each of the first, second, third and fourth linearly polarised main output light beams 32a, 32b, 32c and 32d into the back focal plane 50 of the objective lens (not shown in FIG. 10) through the first quarter waveplate 90 to form circularly polarised main output light beams and then through the pizza polariser 70 to form first, second, third and fourth tangentially polarised main output light beams 34a, 34b, 34c and 34d respectively. The objective lens (not shown in FIG. 10) collimates and interferes the first, second, third and fourth tangentially polarised main output light beams 34a, 34b, 34c and 34d at a sample position in or on the sample (not shown in FIG. 10) to form an interference pattern for illumination of the sample (not shown in FIG. 10). Illumination of the sample (not shown in FIG. 10) with the interference pattern excites fluorescence in the illuminated regions of the sample (not shown in FIG. 10). A portion of the fluorescence (not shown in FIG. 10) is collected by the objective lens (not shown in FIG. 10) and is reflected by the dichroic mirror (not shown in FIG. 10) and imaged onto the image sensor (not shown in FIG. 10) by the imaging lens (not shown in FIG. 10).

One of ordinary skill in the art will understand that the controller (not shown in FIG. 10) may rotate each MEMS mirror 30a, 30b, 30c, 30d around its corresponding first and second orthogonal axes and/or translate each MEMS mirror 30a, 30b, 30c, 30d along its corresponding third axis to form many different focal position arrangements of the first, second, third and fourth tangentially polarised main output light beams 34a, 34b, 34c and 34d in the back focal plane 50 of the objective lens (not shown in FIG. 10) so that the objective lens (not shown in FIG. 10) may form many different interference patterns in or on the sample (not shown in FIG. 10) according to a desired SIM method, for example according to any of the SIM methods described above with reference to FIGS. 9A to 9D.

One of ordinary skill in the art will also understand that various modifications are possible to any of the systems described above. For example, although both of the mirrors 30a and 30b of systems 2, 102, and 202 are MEMS mirrors, only one of the mirrors 30a and 30b may be a MEMS mirror. For example, one of the mirrors 30a and 30b may be a MEMS mirror whilst the other one of the mirrors 30a and 30b may be a moveable mirror of a type other than MEMS e.g. a galvanometric mirror. Although all of the mirrors 30a, 30b, 30c, 30d of the systems 302, 402 and 502 are MEMS mirrors, only one of the mirrors 30a and 30b may be a MEMS mirror and/or only one of the mirrors 30c and 30d may be a MEMS mirror. For example, one of the mirrors 30a and 30b may be a MEMS mirror whilst the other one of the mirrors 30a and 30b may be a moveable mirror of a type other than MEMS e.g. a galvanometric mirror and/or one of the mirrors 30c and 30d may be a MEMS mirror whilst the other one of the mirrors 30c and 30d may be a moveable mirror of a type other than MEMS e.g. a galvanometric mirror.

Although several different examples of focal position arrangements of the first and second output light beams 32a, 32b in the back focal plane 50 of the objective lens 44 and the corresponding different interference patterns formed in or on the sample 4 are described above with reference to FIGS. 1 and 5A-5F, it should be understood that for the first and/or second output light beams 32a, 32b described above with reference to FIGS. 1 and 5A-5F, the focal position in the back focal plane 50 of the objective lens 44 may be varied continuously within an area defined according to the range of tilt and tip angles of the corresponding mirror 30a, 30b. Similarly, the phase of any of the first and second output light beams 32a, 32b described above with reference to FIGS. 1 and 5A-5F, may be varied continuously according to the linear translation range of the corresponding mirror 30a, 30b.

Although several different examples of focal position arrangements of the first and second tangentially polarised output light beams 34a, 34b in the back focal plane 50 of the objective lens 44 and the corresponding different interference patterns formed in or on the sample 4 are described above with reference to FIGS. 2A, 2B, 3 and 6A-6F, it should be understood that for the first and/or second tangentially polarised output light beams 34a, 34b described above with reference to FIGS. 2A, 2B, 3 and 6A-6F, the focal position in the back focal plane 50 of the objective lens 44 may be varied continuously within an area defined according to the range of tilt and tip angles of the corresponding mirror 30a, 30b. Similarly, the phase of any of the first and second tangentially polarised output light beams 34a, 34b described above with reference to FIGS. 2A, 2B, 3 and 6A-6F, may be varied continuously according to the linear translation range of the corresponding mirror 30a, 30b.

Although several different examples of focal position arrangements of the first, second, third and fourth main output light beams 34a, 34b, 34c and 34d in the back focal plane 50 of the objective lens 44 and the corresponding different interference patterns formed in or on the sample 4 are described above, it should be understood that for any of the first, second, third and fourth main output light beams 34a, 34b, 34c and 34d, the focal position in the back focal plane 50 of the objective lens 44 may be varied continuously within an area defined according to the range of tilt and tip angles of the corresponding mirror 30a, 30b, 30c, 30d. Similarly, the phase of any of the first, second, third and fourth main output light beams 34a, 34b, 34c and 34d may be varied continuously according to the linear translation range of the corresponding mirror 30a, 30b, 30c, 30d.

In a variant of system 102, the circular polariser 80 and the pizza polariser 70 may be replaced by a linear polariser followed by an m=1 vortex half-wave retarder, wherein the linear polariser and the m=1 vortex half-wave retarder are both positioned after the beam splitter 20 between the focusing lens 40 and the back focal plane 50 of the objective lens 44. Similarly, in a variant of system 302, the circular polariser 80 and the pizza polariser 70 may be replaced by a linear polariser followed by an m=1 vortex half-wave retarder, wherein the linear polariser and the m=1 vortex half-wave retarder are both positioned after the main beam splitter 20c between the focusing lens 40 and the back focal plane 50 of the objective lens 44.

In a variant of system 202, the quarter waveplate 90 and the pizza polariser 70 may be replaced by a linear polariser followed by an m=1 vortex half-wave retarder, wherein the linear polariser and the m=1 vortex half-wave retarder are both positioned after the beam splitter 60 between the focusing lens 40 and the back focal plane 50 of the objective lens 44. Similarly, in a variant of either system 402 or 502, the quarter waveplate 90 and the pizza polariser 70 may be replaced by a linear polariser followed by an m=1 vortex half-wave retarder, wherein the linear polariser and the m=1 vortex half-wave retarder are both positioned after the main beam splitter 20 between the focusing lens 40 and the back focal plane 50 of the objective lens 44.

Each of systems 2, 102, 202, 302, 402, 502 comprises an optical coupling arrangement which comprises a focussing lens 40, an objective lens 44 and a dichroic mirror 52 for optically coupling the output light beams 32a, 32b described with reference to FIG. 1, the tangentially polarised output light beams 34a, 34b described with reference to FIGS. 2A, 2B and 3, or the tangentially polarised main output light beams 34a, 34b, 34c, 34d described with reference to FIGS. 7 and 8 to a first side of a sample 4 and for optically coupling at least a portion of the generated electromagnetic radiation emitted from the first side of the sample 4 to the image sensor arrangement 54, 56. In an alternative variant of each system 2, 102, 202, 302, 402, 502 the optical coupling arrangement may be configured to optically couple the output light beams 32a, 32b described with reference to FIG. 1, the tangentially polarised output light beams 34a, 34b described with reference to FIGS. 2A, 2B and 3, or the tangentially polarised main output light beams 32a, 32b, 32c, 32d to a first side of the sample and the system may comprise a further optical coupling arrangement for optically coupling at least a portion of the generated electromagnetic radiation emitted from a second side of the sample to the image sensor arrangement, wherein the second side of the sample is opposite to the first side of the sample.

In any of the systems 2, 102, 202, 302, 402, 502, the input light beam 10 may be polarised, for example linearly polarised. The input light beam 10 may comprise coherent light such as laser light.

In a variant of any of the systems 102, 202, 302, 402, 502, the circular polariser 80 may be replaced by a quarter waveplate when the input light beam 10 is linearly polarised, for example because the input light beam 10 is generated by a linearly polarised optical source.

Any of the systems 2, 102, 202 may include an optical source for generating the input light beam 10. For example, any of the systems 2, 102, 202 may comprise a coherent optical source such as a laser for generating the input light beam 10. The optical source may be configured to generate the input light beam with a linear polarisation.

Any of systems 2, 102, 202 may include a plurality of optical sources and an optical combiner arrangement for combining light from the plurality of optical sources to form the input light beam 10. One or more of the optical sources may be configured to emit light of a wavelength which is different to a wavelength of the light emitted by the one or more other optical sources and/or wherein one or more of the optical sources is configured to emit light having an optical spectrum which is different to an optical spectrum of the light emitted by the one or more other optical sources.

Any of systems 302, 402, 502 may include an optical source for generating the main input light beam 10. For example, any of systems 302, 402, 502 may comprise a coherent optical source such as a laser for generating the main input light beam 10. The optical source may be configured to generate the main input light beam with a linear polarisation.

Any of systems 302, 402, 502 may include a plurality of optical sources and an optical combiner arrangement for combining light from the plurality of optical sources to form the main input light beam 10. One or more of the optical sources may be configured to emit light of a wavelength which is different to a wavelength of the light emitted by the one or more other optical sources and/or wherein one or more of the optical sources is configured to emit light having an optical spectrum which is different to an optical spectrum of the light emitted by the one or more other optical sources.

Although the system has been described in terms of preferred embodiments as set forth above, it should be understood that these embodiments are illustrative only and that the claims are not limited to those embodiments. Those skilled in the art will be able to make modifications and alternatives to the described embodiments in view of the disclosure which are contemplated as falling within the scope of the appended claims. Each feature disclosed or illustrated in the present specification may be incorporated in any embodiment, whether alone or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of reference signs in the claims should not be construed as limiting the scope of the claims.

1. A system for use in structured illumination microscopy (SIM), the system comprising:
a beam splitter for splitting an input light beam into first and second light beams,
a first mirror for reflecting the first light beam back to the beam splitter; and
a second mirror for reflecting the second light beam back to the beam splitter,
wherein the beam splitter at least partially transmits or reflects the reflected first light beam to form a first output light beam and the beam splitter at least partially transmits or reflects the reflected second light beam to form a second output light beam,
wherein one or both of the first and second mirrors comprises a micro-electro-mechanical systems (MEMS) mirror, and
wherein each MEMS mirror is rotatable around a corresponding first axis, each MEMS mirror is rotatable around a corresponding second axis, and each MEMS mirror is configured for translation along a corresponding third axis which is orthogonal to the corresponding first and second axes.

2. The system as claimed in claim 1, wherein at least one of:
the system is configured so that an optical axis of the first mirror is parallel to, or co-axial with, the first light beam and the optical axis of the first mirror is parallel to, or co-axial with, the third axis of the first mirror;
the system is configured so that an optical axis of the second mirror is parallel to, or co-axial with, the second light beam and the optical axis of the second mirror is parallel to, or co-axial with, the third axis of the second mirror; or
the beam splitter is configured so that the first and second light beams propagate along orthogonal directions.

3. The system as claimed in claim 1, wherein at least one of:
there are no optical components located between the beam splitter and the first mirror; or
there are no optical components located between the beam splitter and the second mirror.

4. The system as claimed in claim 1, wherein the beam splitter comprises a non-polarising beam splitter, and wherein the system comprises a polarisation control arrangement for controlling or selecting a polarisation of the first output light beam and for controlling or selecting a polarisation of the second output light beam to form first and second tangentially polarised output light beams having the same tangential linear polarisation relative to an optical axis of the polarisation control arrangement.

5. (canceled)

6. The system as claimed in claim 1, wherein the beam splitter comprises a polarising beam splitter, and wherein comprising a polarisation control arrangement for controlling or selecting a polarisation of the first output light beam and a polarisation of the second output light beam to form first and second tangentially polarised output light beams having the same tangential linear polarisation relative to an optical axis of the polarisation control arrangement.

7. (canceled)

8. The system as claimed in claim 1, the system comprising:
a main beam splitter for splitting a main input light beam into the input light beam and a further input light beam;
a further beam splitter for splitting the further input light beam into third and fourth light beams;
a third mirror for reflecting the third light beam back to the further beam splitter; and
a fourth mirror for reflecting the fourth light beam back to the further beam splitter,
wherein the further beam splitter at least partially transmits or reflects the reflected third light beam to form a third output light beam and the further beam splitter at least partially transmits or reflects the reflected fourth light beam to form a fourth output light beam,
wherein the main beam splitter at least partially transmits or reflects the first output light beam to form a first main output light beam, at least partially transmits or reflects the second output light beam to form a second main output light beam, at least partially transmits or reflects the third output light beam to form a third main output light beam, and at least partially transmits or reflects the fourth output light beam to form a fourth main output light beam,
wherein one or both of the third and fourth mirrors comprises a micro-electro-mechanical systems (MEMS) mirror, and
wherein each MEMS mirror is rotatable around a corresponding first axis, each MEMS mirror is rotatable around a corresponding second axis, and each MEMS mirror is configured for translation along a corresponding third axis which is orthogonal to the corresponding first and second axes.

9. The system as claimed in claim 8, wherein at least one of:
the system is configured so that an optical axis of the third mirror is parallel to, or co-axial with, the third light beam and the optical axis of the third mirror is parallel to, or co-axial with, the third axis of the third mirror;
the system is configured so that an optical axis of the fourth mirror is parallel to, or co-axial with, the fourth light beam and the optical axis of the fourth mirror is parallel to, or co-axial with, the third axis of the fourth mirror; and
the beam splitter is configured so that the third and fourth light beams propagate along orthogonal directions.

10. The system as claimed in claim 8, or wherein at least one of:
there are no optical components located between the further beam splitter and the third mirror; or
there are no optical components located between the further beam splitter and the fourth mirror.

11. The system as claimed in claim 8, wherein the main beam splitter, the beam splitter and the further beam splitter comprise non-polarising beam splitters, and wherein the system comprises a polarisation control arrangement for controlling or selecting a polarisation of at least two of the first, second, third and fourth main output light beams.

12. (canceled)

13. The system as claimed in claim 8, wherein the main beam splitter comprises a non-polarising beam splitter and the beam splitter and the further beam splitter comprise polarising beam splitters, and wherein the system comprises a polarisation control arrangement for controlling or selecting a polarisation of at least two of the first, second, third and fourth main output light beams.

14. (canceled)

15. The system as claimed in claim 8, wherein:
there are no optical components located between the main beam splitter and the beam splitter; and
there are no optical components located between the main beam splitter and the further beam splitter.

16. The system as claimed in claim 8, wherein the main beam splitter, the beam splitter and the further beam splitter comprise polarising beam splitters.

17. The system as claimed in claim 16, comprising a polarisation control arrangement for controlling or selecting a polarisation of at least two of the first, second, third and fourth main output light beams, and wherein the polarisation control arrangement comprises a first quarter waveplate located between the main polarising beam splitter and the polarising beam splitter and a second quarter waveplate located between the main polarising beam splitter and the further polarising beam splitter.

18. (canceled)

19. The system as claimed in claim 1, comprising an optical coupling arrangement for optically coupling the first and second output light beams, or at least two of the first, second, third and fourth main output light beams, to a sample at a sample position so as to generate an interference pattern for the generation of electromagnetic radiation such as fluorescence in the regions of the sample illuminated by the interference pattern.

20. The system as claimed in claim 19, wherein the optical coupling arrangement comprises a focussing arrangement such as a focussing lens and a collimating arrangement such as an objective lens,
wherein the focussing arrangement is configured to focus each of the first and second output light beams, or each of at least two of the first, second, third and fourth main output light beams, to a corresponding focal position in a back focal plane of the collimating arrangement so that the collimating arrangement collimates and interferes the first and second output light beams, or at least two of the first, second, third and fourth main output light beams, at the sample position to form the interference pattern at the sample position.

21. The system as claimed in claim comprising an image sensor arrangement,
wherein the optical coupling arrangement is configured to optically couple the first and second output light beams, or at least two of the first, second, third and fourth main output light beams, to a first side of the sample and to optically couple at least a portion of the generated electromagnetic radiation emitted from the first side of the sample to the image sensor arrangement, or
wherein the optical coupling arrangement is configured to optically couple the first and second output light beams, or at least two of the first, second, third and fourth main output light beams, to a first side of the sample and the system comprises a further optical coupling arrangement for optically coupling at least a portion of the generated electromagnetic radiation emitted from a second side of the sample to the image sensor arrangement, wherein the second side of the sample is opposite to the first side of the sample.

22. The system as claimed in claim 21, comprising a controller configured to control:
a rotation of each MEMS mirror around the corresponding first axis;
a rotation of each MEMS mirror around the corresponding second axis; and
a position of each MEMS mirror along the corresponding third axis.

23. The system as claimed in claim 22, wherein the controller is configured to control the image sensor arrangement to capture an image of the electromagnetic radiation emitted from the sample when the sample is illuminated by an interference pattern corresponding to each focal position arrangement of a plurality of focal position arrangements and to reconstruct an image of the sample based on the captured images, wherein each focal position arrangement comprises an arrangement of the first and second output light beams, or of at least two of the first, second, third and fourth main output light beams, in the back focal plane of the collimating arrangement.

24. The system as claimed in claim 23, wherein the controller is configured to control each MEMS mirror for 2D SIM, 3D SIM, square lattice SIM, hexagonal lattice SIM or non-linear SIM.

25. A structured illumination microscopy (SIM) system comprising:
the system for use in SIM as claimed in claim 1; and
one or more optical sources such as one or more coherent optical sources for generating the input light beam or the main input light beam.
